(19) United States
(12) Patent Application Publication
(10) Pub. No.: US 2013/0264386 A1
(43) Pub. Date: Oct. 10, 2013

(54) Tap to enter: Method and system for unlocking secured areas/vestibules via contactless enabled financial instruments, cards and devices

(71) Applicant: David Michael Greenspan, New York, NY (US)

(72) Inventor: David Michael Greenspan, New York, NY (US)

(21) Appl. No.: 13/441,836

(22) Filed: Apr. 6, 2012

(51) Int. Cl. G06K 5/00

(52) U.S. Cl. 235/382

(57) ABSTRACT

Method and system for allowing entry to physically secured areas based on the detected presence of a contactless enabled financial instrument, financial card or financial device, including the ability to unlock or allow entry to a secured area. One embodiment includes the unlocking/allowing of entry into a secured/locked A.T.M. vestibule when a contactless enabled financial instrument, financial card or financial device is detected or tapped on a Contactless Card/Device Reader. Embodiments may include integrating into existing locking systems or working in parallel/complimentary fashion without direct integration.

### BACKGROUND

The present disclosure generally relates to entry of secured areas (ex. such as

A.T.M. vestibules) by tapping or holding a financial instrument such as a contactless financial instrument/card/device near a contactless card/device reader. This is novel in that such contactless entry functionality is typically limited to entry access control cards (Ex. building passes/work ID badges) or contact based financial instruments (swipe based debit/credit cards) and not contactless financial instruments/devices. This Tap To Enter method and system would allow for entry to secure areas based on a contactless enabled financial card/device (such as a contactless enabled debit card or credit card). Example: A bank customer can enter a locked A.T.M. vestibule by simply tapping their contactless enabled debit card on the contactless reader.

### BRIEF SUMMARY

A method for allowing access to a secured/locked area based upon the detection a contactless enabled financial instrument, card or device. This would allow for easy entry into a secured area by simply tapping, or briefly holding the contactless enabled financial instrument, card or device to an appropriate card/device reader.

In one embodiment/scenario, a customer may wish to quickly enter a secured area where they would typically need to swipe a credit/debit/financial card. Instead of swiping their card they could simply hold their contactless enabled card/device to the reader to gain entry in a faster/easier manner than needing to swipe.

Additionally this Tap To Enter method and system could have ancillary benefits to the financial instrument/card/device issuer as it could encourage additional use of the financial instrument/card/device. It would be first physical entry system that would allow a customer to enter a secured area using a contactless enabled financial instrument. This could encourage customers to use that card/device more frequently and/or spend more often with their contactless cards/devices.

Furthermore, this Tap To Enter method and system could allow both entry into as well as exit from the secured area. (Ex. customer could tap their contactless enabled card/device to enter as well as exit the secured area.)

### SUMMARY OF DISCLOSURE

### Brief Description of the Drawings/Figures

The features and advantages of the present invention will become more apparent from the detailed description set forth below, when taken in conjunction with the drawings, in which like reference numbers indicate identical or functionally similar elements. Additionally, the left most digit of a reference number identifies the drawing in which the reference number first appears. Any additional number after the figure preceded by a dash references a corresponding module related to the aforementioned figure number.

FIG. 1 is a flow chart diagram of an exemplary system, of how a person would enter using a contactless enabled card/device/financial instrument in accordance with an embodiment of the invention.

FIG. 2 is an exemplary diagram of the Tap To Enter method and systems components, according to the embodiment of the present disclosure.

### DETAILED DESCRIPTION

The detailed description of exemplary embodiments of the invention herein makes reference to the accompanying drawings and figures, which show the exemplary embodiments by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. It will be apparent to a person skilled in the pertinent art that this invention can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional means for communication and deployment between a contactless reader and a contactless enabled card/device/financial instrument may not be described in detail herein (ex. communication protocols, device handshakes, authentication means and the like). Furthermore, the connecting lines shown in the various figures contained herein are intended to represent exemplary functional relationships and/or physical couplings between the various components. It should be noted that many alternative or additional functional relationships or physical connections may be present in a practical system.

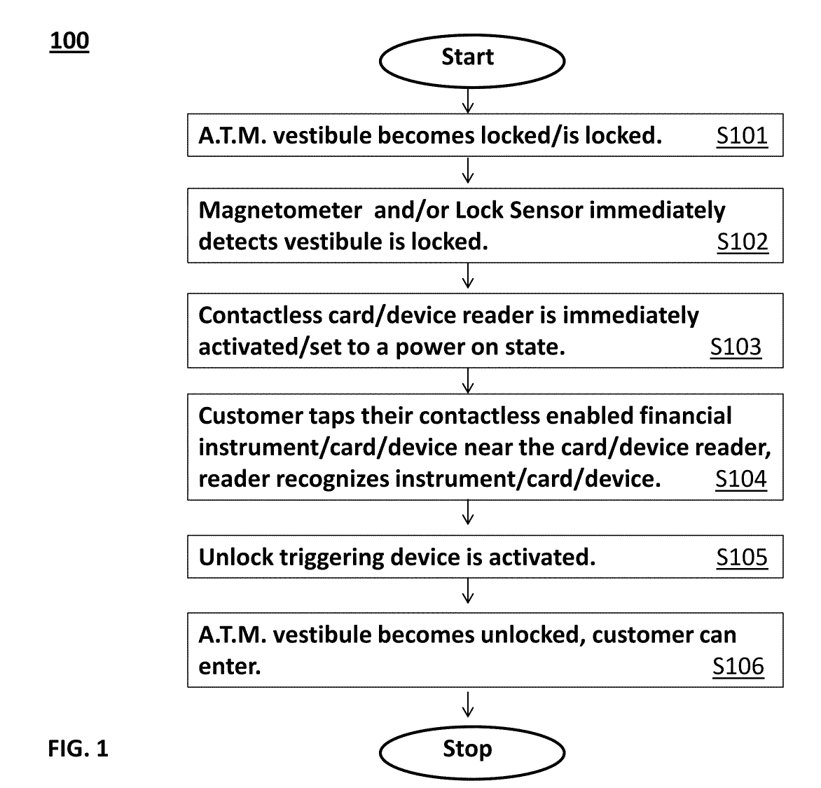

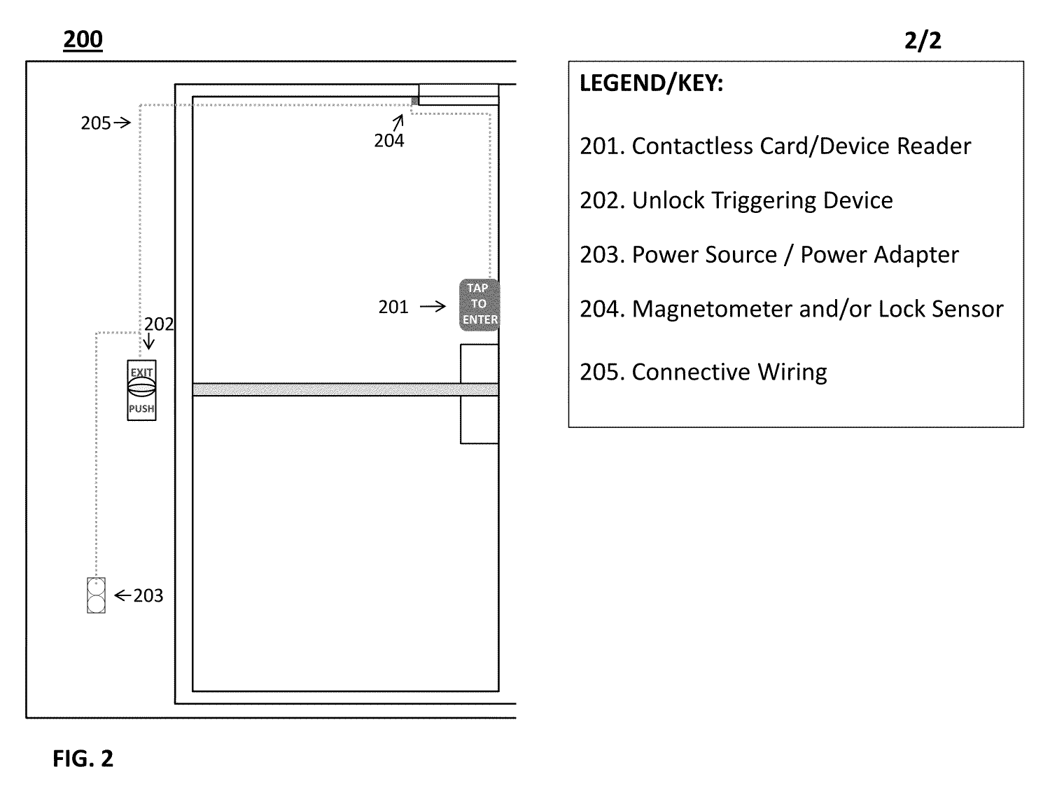

FIG. 1. Is a flowchart of an exemplary process 100 for allowing entry to a secured area/A.T.M. vestibule via a contactless enabled financial instrument/card/device, according to one embodiment. In step S101 the A.T.M. vestibule becomes locked/is locked. In step S102 the Magnetometer and/or Lock Sensor (corresponding to FIG. 2.—module 204) detects the state of the locking mechanism as being set to locked. In step S103 the Contactless Card/Device Reader (corresponding to FIG. 2—module 201) becomes activated/set to a power on state. In step S104 the customer holds their contactless enabled financial instrument/card/device to the Contactless Card/Device Reader (corresponding to FIG. 2—module 201). The Contactless Card/Device Reader (corresponding to FIG. 2—module 201) recognizes the contactless enabled financial instrument. In Step S105 the Unlock Triggering Device (corresponding to FIG. 2.—module 202) is activated/engaged and triggers the unlocking mechanism. In step S106 the secured area/A.T.M. vestibule becomes unlocked and the customer/bearer of the contactless enabled card/device/financial instrument can enter.

FIG. 2.—module 201 is an exemplary device corresponding to a Contactless Card/Device Reader component. This is a device which can interpret/communicate and/or validate a contactless card or contactless device. These contactless cards/devices referenced are typically of a financial instrument nature (ex. debit card/credit card/mobile wallet) and can include contactless technology typical of the financial services industry. This would be including but not limited to support for any combination of the following technologies NFC, RFID, EMV, OneSmart MasterCard PayPass, OneSmart MasterCard Pre-Authorized, American Express ExpressPay, Visa payWave , Discover Zip, JCB J Speedy, QuicPay, isis, Google wallet, PULSE contactless, STAR contactless, as well as additional contactless credit, contactless debit, contactless prepaid, contactless EBT cards and contactless phone/mobile wallet technology.

FIG. 2.—module 202 is an exemplary device corresponding to a Unlock Triggering Device, i.e. a component/ method to unlock the secured area (ex. locked ATM vestibule). Specifically, the component enables the locking mechanism to disengage. This can be done by physically triggering/depressing an exit button/lever/component or can be via electronically triggering/disengaging the lock mechanism. This electronic method for disengaging the lock may involve direct integration into any existing locking mechanism or may exist separately without integration to any locking mechanism(s)/component(s).

FIG. 2.—module 203 is an exemplary device corresponding to a Power Source/Power Adapter, i.e. a means/component to power the Tap To Enter method and system and/or any additional components. It is a means to provide electricity at the appropriate level to the components and/or system.

FIG. 2.—module 204 is an exemplary device corresponding to a Magnetometer and/or Lock Sensor, i.e. a component which can detect the current status of the locking mechanism. This component may be a magnetometer or similar device to detect/sense if a magnetic locking system is currently engaged. Additionally the lock sensor may be of another non-magnetic means based on the appropriate need/method to detect the locking mechanisms current status. This magnetometer and/or lock sensor may involve direct integration into any existing locking mechanism and thereby detecting the locked/unlocked state electronically and/or it may exist separately without integration to any locking mechanism(s)/component(s).

FIG. 2.—module 205 is an exemplary diagram labeling corresponding to connective wiring /components of the Tap To Enter method and system. These wiring methods may include discreet or covert connections in an attempt to conceal any wiring/connective components from view. These wiring components may involve direct integration into any existing locking mechanism or may exist separately without integration to any locking mechanism(s)/component(s).

1. A method of allowing entry into a physically secured area by means of detecting a contactless enabled financial instrument, financial device or financial card, comprising:
The detection of a contactless enabled financial instrument, financial device or financial card and a means of unlocking or allowing entry into a physically secured area based on the detection of a contactless enabled financial instrument, financial device or financial card.

2. The method of claim 1, wherein containing the ability to altering the state of a locking mechanism based on the detection of a contactless enabled financial instrument, device or card.

3. The method of claim 1, further comprising the ability to directly integrate with existing locking systems and/or mechanisms if needed.

4. The method of claim 1, further comprising the ability to exist in parallel or compliment with existing locking systems and/or mechanisms if needed.
